(19) United States
(12) Patent Application Publication
(10) Pub. No.: US 2026/0101200 A1
(43) Pub. Date: Apr. 9, 2026

(54) COMMUNICATION NETWORK RECONFIGURATION FOR ELECTRICAL POWER EVENTS

(71) Applicant: AT&T Intellectual Property I, L.P., Atlanta, GA (US)

(72) Inventors: Rohit Abhishek, Dawsonville, GA (US); Farooq Bari, Kirkland, WA (US)

(21) Appl. No.: 18/907,014

(22) Filed: Oct. 4, 2024

(51) Int. Cl. H04W 24/02; H04L 41/0896

(52) U.S. Cl. CPC H04W 24/02; H04L 41/0896

(57) ABSTRACT

A processing system including at least one processor of a communication network may detect an electrical power event of an alternating current electrical power distribution network. The processing system may next select one or more remedial actions in the communication network in response to a severity level of the electrical power event, where the processing system is configured to apply different sets of one or more remedial actions for different severity levels of electrical power events. The processing system may then implement the one or more remedial actions to reconfigure the communication network in response to the severity level of the electrical power event.

The present disclosure relates generally to communication network operations, and more particularly to methods, computer-readable media, and apparatuses for implementing one or more remedial actions in a communication network in response to a severity level of a detected electrical power event.

### BACKGROUND

Upgrading a communication network to a software defined network (SDN) architecture implies replacing or augmenting existing network elements that may be integrated to perform a single function with new network elements. The replacement technology may comprise a substrate of networking capability, often called network function virtualization infrastructure (NFVI) that is capable of being directed with software and SDN protocols to perform a broad variety of network functions and services. Different locations in the communication network may be provisioned with appropriate amounts of network substrate, and to the extent possible, routers, switches, edge caches, middle-boxes, and the like, may be instantiated from the common resource pool.

### SUMMARY

The present disclosure describes methods, computer-readable media, and apparatuses for implementing one or more remedial actions in a communication network in response to a severity level of a detected electrical power event. For instance, in one example, a processing system including at least one processor of a communication network may detect an electrical power event of an alternating current electrical power distribution network. The processing system may next select one or more remedial actions in the communication network in response to a severity level of the electrical power event, where the processing system is configured to apply different sets of one or more remedial actions for different severity levels of electrical power events. The processing system may then implement the one or more remedial actions to reconfigure the communication network in response to the severity level of the electrical power event.

### BRIEF DESCRIPTION OF THE DRAWINGS

The teachings of the present disclosure can be readily understood by considering the following detailed description in conjunction with the accompanying drawings, in which:

FIG. 1 illustrates an example network related to the present disclosure;

FIG. 2 illustrates a flowchart of an example method for implementing one or more remedial actions in a communication network in response to a severity level of a detected electrical power event; and

FIG. 3 illustrates a high level block diagram of a computing device specifically programmed to perform the steps, functions, blocks and/or operations described herein.

To facilitate understanding, identical reference numerals have been used, where possible, to designate identical elements that are common to the figures.

### DETAILED DESCRIPTION

Examples of the present disclosure describe methods, computer-readable media, and apparatuses for implementing one or more remedial actions in a communication network in response to a severity level of a detected electrical power event. In particular, examples of the present disclosure relate to the field of wireless network (e.g., cellular network) management and power optimization. To further illustrate, examples of the present disclosure enable a wireless network to activate power/energy-saving modes during electrical power events, e.g., associated with alternating current (AC) electrical power signals, such as blackouts or electrical power grid overload situations. In various examples, the present disclosure may include federated learning and/or machine learning to enhance predictive capabilities and to enable added resilience during electrical power events.

Modern cellular networks are becoming increasingly complex with the deployment of new technologies. This complexity may be associated with higher electrical power/energy consumption and demand for powering network infrastructure. At the same time, in AC electrical power distribution networks (e.g., an electrical power grid), outages and overload situations may be more frequent due to various factors such as extreme weather events and ageing infrastructure. These situations can significantly disrupt wireless network operations. For example, blackouts, brownouts, or electrical power grid overload can lead to network service disruptions. For instance, users may experience call drops, data connectivity issues, and even complete network service outages in affected areas. Network equipment damage may also result from these electrical power events. For example, electrical power surges or sudden loss of electrical power can damage network equipment, leading to additional downtime for repairs. This may also result in increased network operational costs, which may include activating backup power solutions (e.g., diesel generators) to maintain minimal service during electrical power events.

Existing electrical power management strategies in wireless networks may typically rely on reactive measures. For instance, a network operator may manually monitor electrical power levels and initiate service shutdowns during emergencies, leading to delays and potential service disruptions. Alternatively, or in addition, a network operator may implement static power reduction techniques, which may involve fixed power-saving measures across the network, regardless of the severity of the electrical power event. This can lead to unnecessary network service reduction even during minor electrical power fluctuations. The reactive and static nature of prior power management approaches may have several additional limitations. For instance, these techniques may fail to predict or prepare for potential electrical power events, leading to delayed service disruptions. Moreover, static approaches may fail to optimize electrical power/energy consumption based on the real-time electrical power situation and network traffic demands. In addition, network service shutdowns or unnecessary network service reductions may significantly impact user experience and network performance.

In contrast, examples of the present disclosure may predict/forecast electrical power events. For instance, examples of the present disclosure may include advanced analytics processing, e.g., via one or more machine learning (ML) models, to predict potential electrical power events, such as blackouts, brownouts, and/or electrical power grid overload situations, and the severity thereof, based on historical data and AC electrical power distribution network status updates. In one example, the present disclosure may optimize electrical power/energy saving via dynamic adjustment of various configurable parameters of the network based on the severity of the electrical power event and the network traffic load. In one example, the present disclosure may seek to maintain network performance and minimize service disruptions for endpoint devices/users during power emergencies, while at the same time implementing remedial actions to reduce electrical power consumption of the network. In addition, in one example, the present disclosure may prioritize and help ensure continued operation of critical services, e.g., emergency calls and text alerts (e.g., short message service (SMS) alerts or the like) even during more severe electrical power events, such as a blackout in an extended area.

In one example, the present disclosure may operate within a cellular network including a radio access network (RAN), core network (CN), and an operation, administration, and maintenance (OAM) system. In one example, the present disclosure may comprise a new power monitoring and detection functionality (PMDF), e.g., a module comprising code, instructions, data values, etc., which may be loaded into memory and executed by a processing system including at least one processor within the OAM system. In one example, the present disclosure may continuously collect power supply voltage and current levels (e.g., via smart power supplies and/or other power monitoring sensors integrated within the network elements) and may then process the collected electrical power data to detect blackouts, electrical power distribution network overload, and/or other types of electrical power events. For instance, in one example, the present disclosure may analyze the electrical power data using predefined thresholds and algorithms to detect deviations from normal power levels, indicating one or more types of electrical power events. It should be noted that electrical power “events” are not limited to acute outages or the like, but may include, for example, minor degradations in AC electrical power signal quality over an extended period of time, such as hours or days, moderate or severe degradations over short or intermediate durations of time (or over extended periods of time), and so forth.

Alternatively or in addition, the present disclosure may monitor AC electrical power data/parameters (e.g., voltage, frequency, etc.) using dedicated sensors, e.g., deployed in various data centers and associated with different racks, chassis, blades, and other network equipment, or by receiving updates from external sources. For example, a wireless network may be in communication with one or more computing systems of an AC electrical power distribution network to access real-time and/or historical electrical power data (e.g., voltage fluctuations, frequency fluctuations, projected load demands, etc.). To illustrate, a wireless network and an AC electrical power distribution network may implement one or more data exchange protocols (e.g., one or more application programming interfaces (APIs)) for secure information sharing. As such, the wireless network and AC electrical power distribution network may collaborate on forecasting and AC electrical power distribution management strategies to optimize wireless network power consumption. In one example, more critical core network functionalities, e.g., emergency call services, such as 911/E911, SMS messaging for critical alerts, authentication and authorization services, or the like may be prioritized to help ensure continued operation at lower electrical power consumption levels during electrical power events.

In one example, the present disclosure may implement multiple severity/power saving levels, e.g., three levels, or the like, associated with varying degrees of network service degradation. In one example, each severity level may have a pre-configured set of one or more actions, e.g., remedial actions, targeting specific network elements, links, and/or functionalities. For instance, a pre-defined prioritization scheme may be established within the core network (and/or within the access network(s)) to help ensure continued operation of critical services at lower electrical power levels. In one example, prioritization may be implemented through traffic shaping and resource allocation mechanisms within the network. To further illustrate, a first severity level, e.g., level 1, may be associated with minor electrical power events with minor impacts. For instance, severity level 1 may involve electrical power events that last on the order of seconds, e.g., electrical power fluctuations or minor overloads of the AC electrical power distribution network. For instance, one or more AC electric power monitoring systems may detect a deviation from normal AC electrical power levels (e.g., voltage fluctuation), a deviation from normal frequency, etc. For severity level 1, the communication network may implement one or more remedial actions to reconfigure the communication network, with only minor affect to endpoint devices (e.g., graceful degradation). For instance, this set of remedial actions may provide an estimated energy savings of 5-10%, and may focus on optimizing resource utilization.

To illustrate, an OAM system (e.g., via a PMDF thereof) may first receive an alert or may detect conditions that indicate an electrical power event of severity level 1 exists. In response, the OAM system may then initiate level 1 power-saving procedures. In one example, the remedial actions may include: temporary suspension or scaling down of non-critical background processes with minimal impact on user experience. For instance, the OAM system may instruct network elements (NEs) to reduce non-essential tasks such as data caching, background processes, and detailed logging. Alternatively, or in addition, the OAM system may configure/reconfigure NEs to operate at a lower processing speed (e.g., in a power-saving mode). In one example, the OAM system may continue to monitor AC electrical power levels (and/or other parameters) and network performance. It should be noted that functionalities/services designated as “critical,” e.g., emergency services calls and SMS services, etc. may remain fully operational (e.g., no change in performance indicators, e.g., “key performance indicators” (KPIs), with respect to these services).

In one example, a second severity level, e.g., level 2, may be associated with moderate electrical power events, e.g., with corresponding moderate network service impacts. For instance, moderate electrical power events may include a blackout or significant overload of the AC electrical power distribution network, e.g., forecast or confirmed as detected by the OAM system, which may last on the order of minutes. In such case, the OAM system may trigger level 2 power-saving procedures, with an estimate energy savings of 20-30%. In particular, remedial actions from level 1 may be intensified, with added focus on reducing non-essential network activities. For instance, the communication network may reduce network capacity for non-essential traffic (e.g., data services) through traffic shaping mechanisms. In addition, level 2 remedial actions may include enforcement of endpoint device connection limits. For instance, the communication network may limit the number of active endpoint device connections to prioritize services designated as critical. When level 2 remedial actions are implemented, network service experience for endpoint devices may be moderately impacted (e.g., slower data speeds, longer service response times for non-critical requests, etc.). In one example, the OAM system may continue to monitor AC electrical power levels (or other parameters) and network performance. It is again noted that critical services/functionalities may remain operational, but with potentially reduced processing overhead.

In one example, a third severity level, e.g., level 3, may be associated with significant electrical power events. For instance, level 3 remedial actions may be triggered when the communication network detects a critical power situation or complete blackout, e.g., a widespread blackout and/or a persistent blackout that last for minutes to hours. The estimated energy saving of level 3 remedial actions may be 50-70%), with a focus on preserving critical functionalities with minimal resource consumption. To further illustrate, in one example, level 3 remedial actions may include shutting down network elements designated as non-essential, such as those supporting general data services (e.g., for non-first responders, or non-governmental users), or configuring such non-essential network elements to operate in standby mode, or the like. For instance, level 3 remedial actions may include only maintaining core network functionalities critical for emergency services and SMS for critical alerts. As such, certain network elements may be placed into a low-power hibernation state, e.g., standby mode, or the like. In one example, the OAM system itself may be configured into standby mode, e.g., with minimal functionality remaining operational for monitoring AC electrical power data to determine when normal network services may be restored. Endpoint devices may experience significant impacts to network services. For example, all call/connection attempts not related to emergency services might fail or experience significant delays.

As an alternative or in addition to the foregoing, remedial actions at one or more of the severity levels may include transmitting instructions to one or more network elements to activate power saving modes and/or reduced network traffic modes. In particular, endpoint devices can also contribute to overall energy conservation during blackouts, brownouts, and/or AC electrical power distribution network overload situations. For example, smartphones and other mobile devices may often have built-in power-saving modes that can be activated manually or automatically under various conditions. These modes typically reduce background processes, lower display brightness, and limit network access to optimize battery life. In one example, the communication network may instruct (and/or request) endpoint devices to activate these power-saving modes during alerts of potential electrical power events to collectively reduce network load (and thus reduce electrical power consumption by the communication network serving such endpoint devices through reduced network traffic data processing, reduced overhead, etc.). Alternatively, or in addition, in one example the communication network may instruct and/or request one or more endpoint devices to prioritize critical network traffic during electrical power events. For example, prioritizing voice calls and SMS alerts over data services can help maintain essential communication channels while helping to minimize the electrical power/energy utilization by the communication network. In still another example, the communication network may implement endpoint device location-based power savings. For instance, network infrastructure can leverage endpoint device location information to identify areas with sufficient network coverage, and potentially reduce transmission power from nearby cell towers. This approach may include determining a minimum transmit power that provide energy utilization savings, while ensuring ongoing service availability for endpoint devices in these areas.

As an alternative or in addition to the foregoing, remedial actions at one or more of the severity levels may include instructing one or more endpoint devices comprising Internet of Things (IoT) devices (e.g., biometric sensors, environmental sensors, etc.) to send data reports to respective management systems, data repositories, or the like on a different schedule. For instance, the IoT devices may be instructed and/or requested to report earlier or later than scheduled, to report less frequently, etc., in response to a predicted or actual electrical power event. In still another example, remedial actions at one or more of the severity levels may alternatively or additionally include instantiating network elements (e.g., virtual network functions (VNFs) or the like) in areas of the network that are not experiencing an electrical power event. For instance, the AC electrical power distribution network structure may be mapped to a network topology, where such a map may be used to decide where to instantiate new network resources in response to brownouts, blackouts, or the like.

In one example, a federated learning model, e.g., one or more machine learning (ML) models (or MLMs), may be trained on anonymized data to predict future AC electrical power signal parameters and/or AC electrical power consumption patterns. The MLM(s) can reside within the OAM system or on individual NEs, and may be trained collaboratively without sharing raw data. In one example, the MLM(s) may be used to generate early warnings of potential electrical power events, to identify the types of events (e.g., blackouts or grid overload), to identify severity levels, and so forth based on various data points of electrical power data from network elements, AC electrical power probes, from the AC electrical power distribution network, and/or from a third party (e.g., another entity that may monitor and report electrical power data associated with the AC electrical power distribution network). In the same or another embodiment, for dynamic power-saving adjustments, one or more MLMs can be deployed within the OAM system (e.g., the PMDF thereof) to analyze real-time electrical power data and network traffic information. For instance, inputs to the MLMs may include historical electrical power data, weather patterns, network traffic data, endpoint device utilization, and/or other data, where the output(s) of the MLMs may include indicators of potential electrical power events (e.g., current or forecast), the types of events, and/or the severity levels. In one example, one or more of the MLMs may also generate one or more outputs which indicate adjustments of power-saving thresholds, e.g., for categorization of electrical power events into different severity levels.

In one example, the present disclosure may further identify endpoint device subscriber segments with high energy-saving potential for targeted subscription offerings. For instance, the electrical power-saving methodology described herein may be integrated into a subscription-based service offered by a network operator. For example, the network operator may offer subscription tiers for power-saving functionalities, providing flexibility, customization, cost savings, and automated power management for endpoint devices/users. To illustrate, the communication network may provide a subscription-based service for priority network service access during electrical power events. In one example, this may include prioritized access to critical services, such as emergency calls and SMS alerts during power emergencies, even under network congestion. In one example, a subscription may enable endpoint devices/users to dynamically control the activation and deactivation of level 2 and level 3 remedial actions, providing maximum flexibility for managing energy consumption and service experience. Alternatively, or in addition, in one example, a network operator may provide incentives for endpoint devices to participate in power savings during electrical power events (e.g., users allowing their endpoint devices to be configured by the communication network to operate in battery saving mode and/or a reduced network utilization mode, or the like). For instance, as an incentive, a communication network may provide bonus data packages or discounts on subscriptions for other services to participating endpoint devices/users.

In one example, the present disclosure may be extended to include a context-aware energy score (CAES). For instance, instead of directly charging for data volume usage, a communication network may process and analyze different data points to generate an energy score for each endpoint device/user session. For instance, in one example, this may involve assigning weights to different factors based on their relative impact on energy consumption. In one example, the factors may include, for instance: data transfer type, network activity level, and user actions. To illustrate, the communication network may recognize that activities with high bandwidth requirements (e.g., video streaming) inherently consume more energy than low-bandwidth tasks (e.g., email). As such, the weighting may be such that a higher energy score is assigned to higher-bandwidth data transfers. In addition, during periods of network congestion, maintaining a connection may involve endpoint devices working harder to maintain connections, such as more frequent retransmission, etc., leading to increased electrical power consumption by communication network (as well as by the endpoint device). As such, a higher network activity may similarly contribute to a higher energy score. Likewise, certain user actions may trigger network activity and impact electrical power/energy consumption. This may include application refresh operations, location updates, data uploads/downloads, and so forth. Thus, the present disclosure may adjust the energy score in response to the frequency and type of user actions.

To support weighted energy scoring, the communication network may collect data on relevant parameters from various sources. For instance, endpoint devices may report data transfer types (e.g., video, audio, text/SMS, etc.) and user actions (e.g., application (app) usage, background refresh operations, etc.). In addition, network infrastructure/NEs may provide information on current network congestion levels in a specific area. The collected data may then be processed and analyzed to generate an energy score for each user session. As noted above, this may include weighting different factors based on their relative impact on energy consumption. For instance, Equation 1 illustrates an example of weighted energy scoring as follows:

$$Energy Score ( ES ) = \sum ( Wi * Fi ( data ) + Wn * Network Activity ( t ) + Wu * User Actions ( u ) . \qquad Equation l$$

In Equation 1, Σ may represent the summation of scores for each data transfer type. Fi(data) may represent a function that assigns a weight based on the specific data transfer type (e.g., video, audio, text). For instance, this function may consider factors such as average data bitrate and typical packet size for each data transfer type. Wn may represent the weight assigned to network activity. Network Activity(t) may comprise a function that reflects the current network congestion level at time t. For example, this could be based on cell load metrics or signal strength measurements on the endpoint device. Wu may represent the weight assigned to user actions. Lastly, user Actions(u) may comprise a function that captures the frequency and type of user actions. This can involve assigning weights to different actions based on their estimated energy impact (e.g., background refresh: low weight, video call: high weight, etc.).

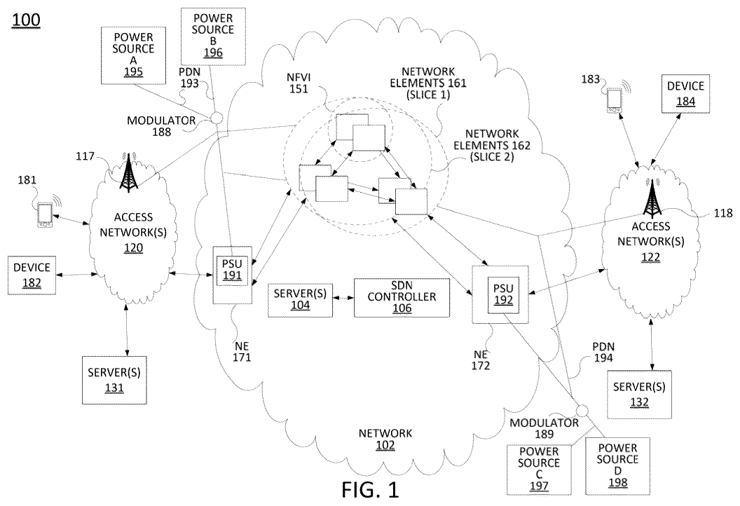

In one example, machine learning may be further implemented for dynamic weight adjustment, e.g., instead of reliance on statically defined weights (Wi). In one example, dynamic weight adjustment may include four phases. For instance, in a data collection phase, the communication network may continuously collect data on energy consumption from endpoint devices (e.g., battery drain rates, or the like). The communication network may also gather real-time network activity data and endpoint device user behavior patterns. In one example, a next phase may include extract relevant features from the collected data for feature engineering such as: average data transfer rate for different data types, network congestion levels in different areas, frequency and type of endpoint device/user actions, relationship between user actions and energy consumption, and so forth. A next phase may include machine learning model (MLM) training, such as training a linear regression model, a random forest, or the like, to predict the energy score based on the extracted features. For instance, in each case, the MLM may use historical data on energy consumption, network activity, and user behavior as inputs to learn the relationships between these factors and actual electrical energy usage. In one example, the MLM may generate outputs comprising weight adjustments for Wi, Wn, and Wu based on the learned relationships. For instance, these adjustments may be applied to Equation 1 in real-time, dynamically adapting the energy score calculation to reflect current network conditions and endpoint device/user behavior. These and other aspects of the present disclosure are discussed in greater detail below in connection with the examples of FIGS. 1-3.

To further aid in understanding the present disclosure, FIG. 1 illustrates an example system 100 in which examples of the present disclosure may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2G, 3G, 4G, 5G, 6G and the like), a long term evolution (LTE) network, and the like, related to the current disclosure. It should be noted that an IP network is broadly defined as a network that uses Internet Protocol to exchange data packets. Additional example IP networks include Voice over IP (VOIP) networks, Service over IP (SoIP) networks, and the like.

In one example, the system 100 may comprise a network 102, e.g., a core network, and one or more access networks 120 and 122, and the Internet (not shown). In one example, network 102 may combine core network components of a cellular network with components of a triple play service network; where triple-play services include telephone services, Internet services and video services (e.g., television services) to subscribers. For example, network 102 may functionally comprise a fixed mobile convergence (FMC) network, e.g., an IP Multimedia Subsystem (IMS) network. In addition, network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Network 102 may further comprise a video broadcast network, e.g., a traditional cable provider network or an Internet Protocol Television (IPTV) network, as well as an Internet Service Provider (ISP) network. In one example, network 102 may include multiple “network slices,” e.g., slices 1 and 2 comprising network elements 161 and 162, respectively. Slices 1-2 may include hardware components, which may comprise physical network elements, or virtual network elements on shared hardware (e.g., virtual network elements, or network functions), and capacity allocations (e.g., bandwidth on a link, etc.). It should be noted that a “slice” may be further characterized by service level and security targets, e.g., minimum throughput, uptime, priority, etc. In one example, network 102 may include one or more servers 104, a software defined network (SDN) controller 106, and network elements (NEs) 171 and 172, as discussed in further detail below. In one example, network 102 may also include a plurality of video servers (e.g., a broadcast server, a cable head-end), a plurality of content servers, an advertising server, and so forth. For ease of illustration, various additional elements of network 102 are omitted from FIG. 1.

In one example, the access networks 120 and 122 may comprise fiber optic access networks (e.g., fiber to the curb (FTTC) and/or fiber to the premises (FTTP) access networks), Digital Subscriber Line (DSL) networks, public switched telephone network (PSTN) access networks, broadband cable access networks, Local Area Networks (LANs), wireless access networks (e.g., an IEEE 802.11/Wi-Fi network and the like), cellular access networks, 3^{rd} party networks, and the like. For example, the operator of network 102 may provide data services, voice/telephony services, cable television services, an IPTV service, a streaming service, or any other types of telecommunication service to subscribers via access networks 120 and 122. In one example, the access networks 120 and 122 may comprise different types of access networks, may comprise the same type of access network, or some access networks may be the same type of access network and other may be different types of access networks. In one example, the network 102 may be operated by a communication network service provider. The network 102 and the access networks 120 and 122 may be operated by different service providers, the same service provider or a combination thereof, or may be operated by entities having core businesses that are not related to communication services, e.g., corporate, governmental or educational institution LANs, and the like. In one example, each of access networks 120 and 122 may include at least one access point, such as a cellular base station, non-cellular wireless access point, a digital subscriber line access multiplexer (DSLAM), a cross-connect box, a serving area interface (SAI), a video-ready access device (VRAD), or the like, for communication with various endpoint devices. For instance, as illustrated in FIG. 1, access network(s) 120 may include at least wireless access point 117 (e.g., a cellular base station). Similarly, access network(s) 122 may include at least wireless access point 118 (e.g., a cellular base station).

In one example, the access network(s) 120 may be in communication with various devices, local networks, and/or computing systems/processing systems. For instance, the access network(s) 120 may be in communication with devices 181 and 182, and server(s) 131. Similarly, the access network(s) 122 may be in communication with devices 183 and 184, and server(s) 132. Devices 181-184 may each comprise a telephone, e.g., for analog or digital telephony, a mobile device, such as a cellular smart phone, a laptop, a tablet computer, etc., a router, a gateway, a desktop computer, a plurality or cluster of such devices, a television (TV), e.g., a “smart” TV, a set-top box (STB), and the like. In one example, any one or more of devices 181-184 may represent one or more user/subscriber devices (e.g., user equipment (UE)/user endpoint devices). In one example, any one or more of devices 181-184 may be equipped with wired and/or wireless networking/communication capability. In this regard, any one or more of devices 181-184 may include transceivers for wireless communications, e.g., for Institute for Electrical and Electronics Engineers (IEEE) 802.11 based communications (e.g., “Wi-Fi”), IEEE 802.15 based communications (e.g., “Bluetooth,” “ZigBee,” etc.), cellular communication (e.g., 3G, 4G/LTE, 5G, 6G, etc.), and so forth. In addition, server(s) 131 and 132 may represent one or more computing devices/processing systems comprising web servers, content servers and/content distribution network (CDN) nodes, database servers, and so forth.

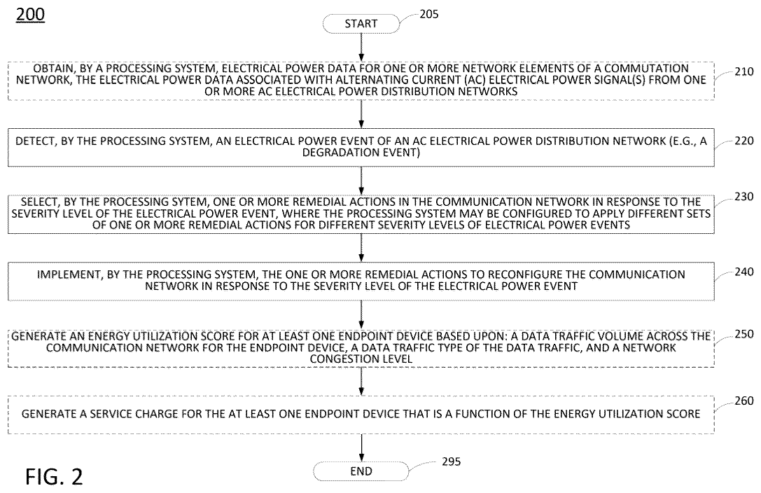

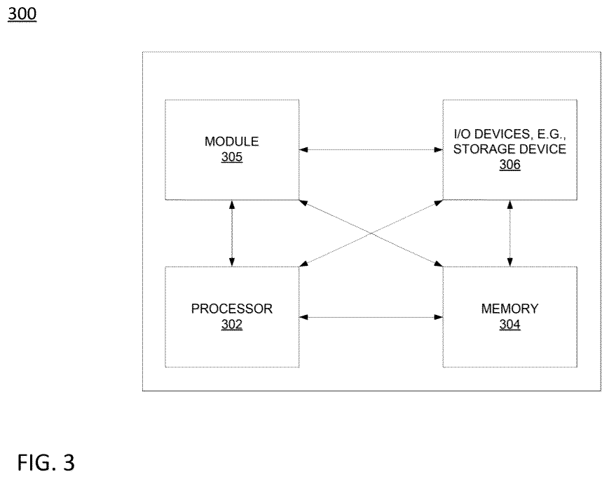

In accordance with the present disclosure, server(s) 104 may comprise a computing system or server, or one or more computing systems or servers, such as computing system 300 depicted in FIG. 3, and may individually or collectively be configured to perform operations or functions for implementing one or more remedial actions in a communication network in response to a severity level of a detected electrical power event (such as illustrated and described in connection with the example method 200 of FIG. 2). Similarly, SDN controller 106 may comprise one or more computing systems or servers, such as computing system 300 depicted in FIG. 3, and may individually or collectively be configured to perform operations or functions in connection with examples of the present disclosure for implementing one or more remedial actions in a communication network in response to a severity level of a detected electrical power event (such as illustrated and described in connection with the example method 200 of FIG. 2).

It should also be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

In one example, the network 102 may comprise network function virtualization infrastructure (NFVI), e.g., servers in a data center or data centers that are available as host devices to host virtual machines (VMs) and/or containers comprising virtual network functions (VNFs). In other words, at least a portion of the network 102 may incorporate software-defined network (SDN) components. In this regard, NFVI 151 is labeled in FIG. 1, and may comprise a node that hosts network elements (e.g., virtual network functions) from both slice 1 and slice 2 (e.g., at least one of network elements 161 and at least one of network elements 162). It should be understood that various others of network elements 161 and network elements 162 may be hosted on other NFVI of network 102. It should also be noted that in accordance with the present disclosure, the term “virtual network function” (or “VNF”), may refer to both virtual machine (VM)-based VNFs, e.g., VNFs deployed as VMs, and containerized or container-based (VNFs), e.g., VNFs deployed as containers, such as within a Kubernetes infrastructure, or the like, also referred to as “cloud-native network functions” (CNFs). To further illustrate, in one example, network elements 161-162 may comprise NFVI, e.g., in accordance with an SDN architecture of network 102, which may be configured to perform the functions of routers, switches, and other devices. For instance, network elements 161-162 may represent virtual provider edge (VPE) routers, virtual mobility management entities (vMMEs), virtual serving gateways (vSGWs), virtual packet data network gateways (vPDNGWs or VPGWs), or other virtual network functions (VNFs). It should be noted that in other, further, and different examples, network elements 161-162 may alternately or additionally comprise physical devices (e.g., dedicated devices) that may include routers, switches, firewalls, gateways, and so forth.

Similarly, in one example, network elements 171 and 172 may comprise gateways, routers, switches, serving gateways (SGWs), mobility management entity (MMEs), packet data network gateways (PGWs or PDNGWs), network slice selection functions (NSSFs), or the like. In one example, network elements 171 and 172 may comprise provider edge (PE) routers interfacing with access network(s) 120 and 122, e.g., for non-cellular network-based communications. In one example, network elements 171 and 172 may also comprise VNFs hosted by and operating on additional NFVI. However, in another example, either or both of network elements 171 and 172 may comprise dedicated devices or components. In one example, network elements 161, 162, 171, and/or 172 may be controlled and managed by the SDN controller 106. For instance, in one example, SDN controller 106 is responsible for such functions as provisioning and releasing instantiations of VNFs to perform the functions of routers, switches, and other devices, initializing routing tables and other operating parameters for the VNFs, and so forth. In one example, SDN controller 106 may maintain communications with VNFs and/or host devices/NFVI via a number of control links which may comprise secure tunnels for signaling communications over an underling IP infrastructure of network 102. In other words, the control links may comprise virtual links multiplexed with transmission traffic and other data traversing network 102 and carried over a shared set of physical links. In accordance with the present disclosure, each of network elements 161, 162, 171, and/or 172 and/or NFVI 151 may comprise a computing system or server, or one or more computing systems or servers, such as computing system 300 depicted in FIG. 3.

To further illustrate, the system 100 may include one or more electrical power distribution networks, e.g., an electric power grid, or power grids, such as power distribution network (PDN 193) and PDN 194. As referred to herein, an electrical power distribution network (e.g., an alternating current (AC) electrical power distribution network) may comprise one or more electrical power distribution lines (e.g., power lines). Each of the PDNs may be connected to one or more power sources, such as power source A (195), power source B (196), power source C (197), and power source D (198). In this regard, it should be noted that some PDNs may have more than one power source that may provide electrical power to the respective PDN. For instance, at any given time, PDN 193 may distribute electrical power from power source A (195), power source B (196), or both. Similarly, PDN 194 may distribute electrical power from power source C (197), power source D (198), or both. As noted above, the different power sources may include solar, wind, hydroelectric, geothermal, coal, natural gas, nuclear, and so forth. It should be noted that although power source A (195), power source B (196), power source C (197), and power source D (198) are illustrated as distinct entities, it should be understood that a power source may comprise multiple power-producing component devices, systems, etc. For instance, power source A (195) may comprise a solar power source that includes a number of solar panels, e.g., a solar panel array, or numerous solar panel arrays that provide electrical power to the PDN 193. Similarly, power source C (197) may comprise a wind power source that includes a number of wind turbines, and so forth.

As illustrated in FIG. 1, PDN 193 may provide electric power (e.g., an alternating current (AC) electric power signal) to various network components, such as NE 171, network elements 161 and/or network elements 162, wireless access point 117, and so forth. Similarly, PDN 194 may provide electric power (e.g., an AC electric power signal) to various network components, such as NE 172, network elements 161 and/or network elements 162, wireless access point 118, and so forth. In accordance with the present disclosure, PDNs may transmit electrical power source information for a source of electrical power via AC electrical power signals. For instance, an AC electrical power signal may be modulated to include electrical power source information for a source of electrical power. To further illustrate, the AC electrical power signal may be modulated to include electrical power source information using power line communication (PLC), e.g., power line carrier communication (PLCC), broadband over power line (BPL), or the like. For example, these types of communication signals may use amplitude modulation (AM) on one or more carrier frequencies to convey digital data. For instance, higher frequency carriers (e.g., 500 Hz, 100 KHz, 200 KHz, or the like) may be used for PLC over AC electrical power signals, e.g., at 60 Hz or the like.

In one example, the electrical power source information may identify a source of the AC electrical power signal (e.g., nuclear reactor X, wind farm Y, solar array Z, etc.) and/or a type of a source of the AC electrical power signal (e.g., solar, wind, hydroelectric, geothermal, coal, natural gas, nuclear, etc.). In one example, the electrical power source information may also include optional information, such as: cost, geographic location of the source, cost information (e.g., cost per kilowatt hour, or the like), and so forth. Alternatively, or in addition, in one example, the electrical power source information may include percentages of electrical power from a plurality of sources to an electrical power distribution network. For instance, an electricity supplier may add electrical power to a power grid/PDN from multiple sources, where it may not be possible or may be challenging to segregate which end consumers of electrical power are receiving electrical power from which source. As such, the electrical power source information may include the types of sources and percentages of a total electrical power delivered to the power grid from the respective sources. In one example, the electrical power source information may include other electrical power data, including information identifying an electrical power event (current or forecast/predicted), e.g., which may be detected by a PDN and notified to the devices within network 102, access networks 120 and 122, etc. In one example, the electrical power data may also include a severity level, a type of electrical power event, a duration or forecast duration, and so forth.

In one example, the electrical power source information may be added via a modulator, or transmitter, such as one of the modulators 188 or 189. For instance, these may inject the higher frequency carrier signals for electrical power source information onto the AC electrical power signal. In one example, the modulators 188 and 189 may be operated by respective electric power suppliers, e.g., associated with PDN 193 and PDN 194, respectively. It should be understood that additional components may be part of the modulators 188 and 189, or may be used in conjunction with the modulators 188 and 189, such as coupling capacitors, low frequency rejecting/blocking filters, high frequency rejecting/blocking filters, repeaters, and so forth.

In addition, in one example, various network components may include power supply modules, or power supply units (PSUs), e.g., “smart” PSUs. For instance, NE 171 may include PSU 191. Similarly, NE 172 may include PSU 192. For ease of illustration, various other network components/elements may include similar power supply modules, such as NFVI 151, and wireless access point 117 and/or wireless access point 118, and so on. To further illustrate, PSU 191 may include a demodulator to extract the electrical power source information (e.g., including electrical power event alerts/notifications) from the AC electrical power signal, e.g., from PDN 193. In one example, the demodulator may comprise a modem for two-way communication over the PDN 193 (e.g., using a PLC/PLCC protocol/technology). PSU 192 may be similarly configured and may have the same or similar components, e.g., a demodulator and/or modem, etc. (and so forth for other network elements having power supplies for converting AC electrical power signals into direct current (DC) electrical currents to power the various components).

Although the foregoing describes network elements obtaining electrical power event information from a modulated AC electric power signal, e.g., via smart power supply modules/units, it should be noted that in various examples, AC electric power signals may not include such modulated information. As such, one or more network elements (e.g., the PSUs thereof) may alternatively or additionally be configured to monitor, detect, record, and/or report parameters/characteristics (broadly, electrical power data) of AC electrical power signals that are received. For instance, the electrical power data may include voltage/amplitude measures (e.g., peak, peak-to-peak, root-mean-square (RMS), etc.), frequency, current measures (e.g., amperage/amperes), etc., and can also include a uniformity measure (e.g., a measure of the stability or volatility of the frequency, current, or other base parameter) or the like. In one example, network elements and/or the PSUs thereof may detect and report electrical power events. Alternatively, or in addition, network elements may obtain and report electric power data, e.g., to server(s) 104, which may use the gathered electrical power data detect electrical power events with respect to network elements and/or zones/regions of the network 102, access networks 102 and 122, etc.

It should be noted that different network elements may obtain AC electrical power from different PDNs. Similarly, an electrical power event may be localized to a portion of a PDN (e.g., less than all of the PDN). Thus, some network elements may be affected by an electrical power events while others are not. To illustrate, in one example, PSU 191 may be configured to provide electrical power data (e.g., the parameters/characteristics of an AC electric power signal received and/or information on specific electrical power events that may be detected at PSU 191) to at least one network element. For instance, this may include the host device in which the PSU 191 is installed and/or with which the PSU 191 is associated (e.g., the PSU 191 may be coupled to the NE 171, but may be external to a chassis, blade, rack, etc. that may house the other components of NE 171). Likewise, in one example, a PSU, such as PSU 191 may be shared among a plurality of network elements, e.g., two or more blades in a rack, etc. In an example in which the PSU 191 provides the electrical power data to the host device (e.g., NE 171), the electrical power data may be forwarded to the host device via an inter-integrated circuit (I2C) communication, a system management bus communication, a serial peripheral interface (SPI) communication, a controller area network communication, or the like. Alternatively, or in addition, PSU 191 may include integrated communication capability, e.g., Wi-Fi, Bluetooth, etc. to provide the electrical power data to one or more network elements, e.g., to the host device, NE 171, and/or others, such as server(s) 104, etc. It should again be noted that PSU 192 may be similarly configured and may thus provide electrical power data to the host device, NE 172, and/or others, such as server(s) 104, etc.

In one example, host devices, such as NE 171, NE 172, etc. may obtain electrical power data extracted from AC electrical power signals, and may further transmit, disseminate, and share this information with other network elements. For instance, each network element, e.g., a host device and/or a power supply module with integrated communication capability, may report electrical power data to server(s) 104 and/or to SDN controller 106. For example, server(s) 104 and/or server(s) 104 in conjunction with SDN controller 106 may comprise an OAM system of the network 102. To illustrate, server(s) 104 may comprise a database system that may collect and store electrical power data associated with for various components of the system 100, e.g., from network 102, and from access networks 120 and 122. In one example, server(s) 104 may comprise a power monitoring and detection functionality (PMDF) as described above.

In accordance with the present disclosure server(s) 104 may utilize the collected electrical power data to detect and respond to electrical power event. For example, server(s) 104 may detect an electrical power event of an AC electrical power distribution network, select one or more remedial actions in the communication network in response to a severity level of the electrical power event, and implement the one or more remedial actions to reconfigure the communication network in response to the severity level of the electrical power event. For instance, server(s) 104 may detect the electrical power event via notification from one or more network elements or from one or more AC electrical power distribution networks directly, e.g., via an API or the like between server(s) 104 and one or more server(s) associated with the AC electrical power distribution network(s), e.g., PDN 193, PDN 194, or the like.

Alternatively, or in addition, server(s) 104 may process electrical power data from various network elements to detect current and/or forecast/predicted electrical power events. For instance, in one example, server(s) 104 may be configured to apply various thresholds, weighted formulas, or the like to the electrical power data, which may indicate an electrical power event. For example, a voltage of an electric power signal below a threshold may be indicative of a level 1 electrical power event; voltage measures of electric power signals for a threshold number or percentage of network elements in a zone below a threshold voltage may be indicative of a level 2 electrical power event; voltage measures of electric power signals for a threshold number or percentage of network elements in a zone below a threshold voltage for more than a threshold duration of time may be indicative of a level 3 electrical power event, and so forth. In one example, factors may be considered together, e.g., via a weighted formula, where a score that exceeds a first threshold may be indicative of a level 1 electrical power event, a score that exceeds a second threshold may be indicative of a level 2 electrical power event, and a score that exceeds a third threshold may be indicative of a level 3 electrical power event. For instance, factors can include a voltage being below (or exceeding) a threshold voltage, a threshold deviation of a frequency of an AC electrical power signal from a normal/expected frequency, a duration of a voltage exceeding or falling below a threshold, a number or percentage of affected network elements in a zone/region, a number of reporting sources (e.g., reporting from network elements/PSUs and corroborated directly from an AC electrical power distribution network), an estimated number of affected endpoint devices, and so forth.

Alternatively, or in addition, server(s) 104 may apply one or more MLMs to detect electrical power events, the locality of the electrical power events (e.g., the network elements and/or network region(s)/zone(s) affected), the severity levels, the types of electrical power events, and so forth. In one example, server(s) 104 may use stored electrical power data as training data for training the one or more MLMs. For example, electrical power data may be time-stamped and labeled/associated with labels indicative of [“electrical power event” or “no electrical power event”], [“electrical power event level 1,” “electrical power event level 2,” “electrical power event level 3,” or “no electrical power event”], [“blackout,” “brownout,” or “excess demand”], or the like, depending upon the particular type of MLM and the configuration thereof (e.g., a binary classifier vs. a multi-class classifier, etc.).

It should be noted that as referred to herein, a machine learning model (MLM) (or machine learning-based model) may comprise a machine learning algorithm (MLA) that has been “trained” or configured in accordance with input training data to perform a particular service. For instance, an MLM may comprise a deep learning neural network, or deep neural network (DNN), a convolutional neural network (CNN), a recurrent neural network (RNN), a long-short term memory (LSTM) model, a transformer network, an encoder-decoder neural network, an encoder neural network, a decoder neural network, a variational autoencoder, a generative adversarial network (GAN), a decision tree algorithm/model, such as gradient boosted decision tree (GBDT) (e.g., XGBoost, XGBR, or the like), and so forth. In one example, one or more MLMs of the present disclosure may include supervised learning and/or reinforcement learning (e.g., using positive and negative examples after deployment as a MLM), and so forth. In one example, MLAs/MLMs of the present disclosure may be in accordance with an open source library, such as OpenCV, which may be further enhanced with domain-specific training data. In one example, multiple MLMs may be employed, such as binary classifiers for each type of electrical power event and/or for each severity level, individual MLMs for respective network elements and/or network zones/regions, and so forth.

In one example, the present disclosure may model the electrical power source data for a network element, or a network zone comprising a plurality of network elements, as a time series in accordance with non-supervised ML techniques. These may include (but are not limited to) a time-series clustering algorithm (e.g., an MLM/MLA) such as k-means clustering or variants thereof (e.g., partitioning around medioids (PAM), k-medioid, etc.), density-based spatial clustering of applications with noise (DBSCAN), and so forth. In one example, a time-series-based MLA/MLM in accordance with the present disclosure may account for trend and seasonality components. For instance, “normal” electrical power data may be different when the source of electrical power is, respectively: solar, wind, nuclear, natural gas, etc., which may vary as the primary source of electrical power at different times of the day and/or seasons of the year, and so forth.

It should be noted that various other types of MLAs and/or MLMs, or other generative and/or classification models may be implemented in examples of the present disclosure. In each case, the inputs to an MLM of the present disclosure may include electrical power data from one or more network elements (e.g., from a defined look-back time window from one or more network elements) and/or from an AC electrical power distribution network, where an output of the MLM may comprise an indication of whether an electrical power event exists or is forecast/predicted, a type of the electrical power event detected, a severity level of the electrical power event, and/or a forecast duration. In addition, one or more MLMs of the present disclosure may be trained in accordance with a training data set comprising historical sets of electrical power data of the one or more network elements (e.g., stored by server(s) 104), where the historical sets of electrical power data are associated with respective labels indicating respective severity levels of electrical power events. It should be noted that in one example, the severity levels can include level 0, e.g., no electrical power event. In other words, some of the training data can include labeled data from when there is no electrical power event. Notably, problems of the AC electrical power distribution network can manifest in the electrical power data of one or more network elements. However, these fluctuations may be difficult to discern and may be learned only over many iterations of training data which may contain fluctuating voltage levels, varying frequency, or other patterns that may be associated with a present or impending electrical power events (and where the patterns in the electrical power data indicative of different severity level(s) may also be learned). In any case, server(s) 104 may train and/or deploy one or more such MLMs that are configured in accordance with the foregoing.

Accordingly, server(s) 104 may, on an ongoing basis, process electrical power data via one or more algorithms/formulas and/or MLMs to detect current or forecast/predicted electrical power events. In addition, server(s) 104 may be configured to apply different sets of one or more remedial actions for different electrical power events and/or severity levels of electrical power events. For instance, as noted above for a first severity level, e.g., severity level 1, remedial actions may include temporary suspension or scaling down of non-critical background processes with minimal impact on user experience and/or configuring/reconfiguring NEs to operate at a lower processing speed (e.g., in a power-saving mode). Similarly, for level 2, remedial actions may include reducing network capacity for non-essential traffic (e.g., data services) through traffic shaping mechanisms and/or enforcement of endpoint device connection limits, e.g., to prioritize services designated as critical. Finally, for level 3, remedial actions that may be implemented by server(s) 104 may include shutting down network elements designated as non-essential, such as those supporting general data services (e.g., for non-first responders, or non-governmental users), configuring such non-essential network elements to operate in standby mode, or the like. In one example, server(s) 104 (e.g., in one example comprising all or a portion of an OAM system) may self-configure to operate in standby mode, e.g., with minimal functionality remaining operational for monitoring AC electrical power data to determine when normal network services may be restored (e.g., the PMDF as described above). Alternatively, or in addition, for one or more of the severity levels, server(s) 104 may transmit instructions to one or more endpoint devices to cause the endpoint devices to activate low power modes and/or to reduce network traffic that is designated as non-critical. In one example, increasing numbers of endpoint devices may be selected for higher severity levels (e.g., level 3 may involve transmitting instructions to more endpoint devices than for level 2) and/or for increasing durations of electrical power events, and so forth.

In one example, server(s) 104 may transmit instructions directly to various network elements. Alternatively, or in addition, server(s) 104 may work in conjunction with SDN controller 106 to configure/reconfigure the network (e.g., to configure/reconfigure various network elements). For instance, server(s) 104 may provide instructions to SDN controller 106 to initiate level 1, level 2, or level 3 power saving procedures, may indicate a target network element, set of network elements, network zone/region, or the like, and so forth. SDN controller 106 may then disseminate instructions to various network elements accordingly. In one example, server(s) 104 may indicate a duration of an electrical power event, e.g., after which SDN controller 106 may transmit instructions to network elements to reconfigure back into a previous or other state of operation. Similarly, in one example, server(s) 104 may work in conjunction with access network components, e.g., wireless access points 117 and 118 (e.g., cellular base stations) to transmit instructions to various endpoint devices for power saving mode activation and/or specifically for reducing non-essential network traffic.

As noted above, network 102 may include multiple “network slices,” e.g., slices 1 and 2 comprising network elements 161 and 162, respectively. In one example, slice 1 may be for general network traffic, while slice 2 may be for first responders, governmental users/entities, etc. Although the description above indicates that slices 1 and 2 may co-exist on shared hardware/NFVI, in one example network elements 161 and 162 may comprise separate sets of hardware. In other words, slice 2 may have a separate, dedicated core. In any event, in accordance with the present disclosure, aspects of remedial actions at level 1, level 2, and/or level 3 may include prioritization of slice 2 over slice 1. For instance, to conserve electrical power consumption, the number of endpoint device connections for general endpoint devices, e.g., slice 1, may be limited, while connections for authorized endpoint devices/users of slice 2 may remain unlimited. Similarly, for level 2, network elements 161 of slice 1 may be placed into standby mode with greater likelihood than network elements 162 of slice 2, and so forth. Alternatively, or in addition, on shared hardware, traffic for slice 1 may be reduced through traffic shaping measures (e.g., blocking, dropping, rate-limiting, etc.) as compared to slice 2 (which may remain unchanged from normal service levels, and/or with less degradation than for slice 1), and so on. These and other aspects of the present disclosure are further described below in connection with the example method 200 of FIG. 2.

In addition, it should be noted that the system 100 has been simplified. Thus, the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as additional border elements, routers, switches, policy servers, security devices, gateways, a content distribution network (CDN), and the like. Similarly, although only two access networks 120 and 122 are shown, in other examples, access networks 120 and/or 122 may each comprise a plurality of different access networks that may interface with network 102 independently or in a chained manner. For example, devices 181 and 182, and server(s) 131, respectively, may be in communication with network 102 via different access networks, and devices 183 and 184, and server(s) 132, may be in communication with network 102 via two or more different access networks, and so forth.

In addition, in one example, SDN controller 106 may comprise or may represent a service and management orchestrator (SMO) and/or a self-optimizing network (SON) orchestrator. To illustrate, an SMO may function as a self-optimizing network (SON) orchestrator that is responsible for activating and deactivating, allocating and deallocating, and otherwise managing a variety of network components. For instance, and SMO may activate and deactivate antennas/remote radio heads (e.g., of wireless access points 117 and 118), may allocate and deactivate baseband units in BBU pool (e.g., associated with wireless access points 117 and 118), and may perform other operations for configuring radio access network (RAN) operations, in accordance with the present disclosure. Similarly, in one example, server(s) 104 may comprise a network data analytics functions (NWDAF), or the network 102 may further include an NWDAF that is in communication with server(s) 104. For instance, the electrical power data collected from network elements may be stored in an NWDAF. In addition, an NWDAF may include various machine learning models that may be applied to the electrical power data to detect current and/or forecast/predicted network power events. Thus, these and other modifications are all contemplated within the scope of the present disclosure.

FIG. 2 illustrates a flowchart of an example method 200 for implementing one or more remedial actions in a communication network in response to a severity level of a detected electrical power event. In one example, the method 200 is performed by a network-based component of the system 100 of FIG. 1, such as by one of server(s) 104 or SDN controller 106, or one or more other network elements, and/or any one or more components thereof, or by server(s) 104 and SDN controller 106 in conjunction with each other and/or in conjunction with one or more other network elements and/or components thereof, such as PSUs, etc. In one example, the steps, functions, or operations of method 200 may be performed by a computing device or system 300, and/or processor 302 as described in connection with FIG. 3 below. For instance, the computing device or system 300 may represent any one or more components of FIG. 1 or the like that is/are configured to perform the steps, functions and/or operations of the method 200. Similarly, in one example, the steps, functions, or operations of method 200 may be performed by a processing system comprising one or more computing devices collectively configured to perform various steps, functions, and/or operations of the method 200. For instance, multiple instances of the computing device or processing system 300 may collectively function as a processing system. For illustrative purposes, the method 200 is described in greater detail below in connection with an example performed by a processing system. The method 200 begins in step 205 and may proceed to optional step 210 or to step 220.

At optional 210, the processing system may obtain electrical power data (e.g., AC electrical power data) for one or more network elements of a commutation network, where the electrical power data may be further associated with AC electrical power signal(s) from one or more AC electrical power distribution networks. In one example, the communication network may comprise a wireless network, e.g., a cellular network. In one example, at least a portion of the electrical power data may be obtained via an AC electrical power distribution line of the AC electrical power distribution network. For instance, in one example, one or more network elements (e.g., the PSUs thereof) may be configured to monitor, detect, record, and/or report parameters/characteristics (broadly, electrical power data) of AC electrical power signals that are received. For instance, the electrical power data may include voltage/amplitude measures (e.g., peak, peak-to-peak, root-mean-square (RMS), etc.), frequency, current measures (e.g., amperage/amperes), etc., and can also include a uniformity measure (e.g., a measure of the stability or volatility of the frequency, current, or other base parameter) or the like. In one example, network elements and/or the PSUs thereof may detect and report electrical power events to the processing system comprising an OAM system, SDN controller, SON orchestrator, RAN intelligent controller, NWDAF, or other management system of the communication network. Alternatively, or in addition, in one example, an AC electrical power signal on the AC electrical power distribution line may be modulated to include electrical power data using a power line carrier communication (PLC/PLCC), which may be received by network elements (e.g., the PSUs thereof) and reported to the processing system.

In another example, the processing system may comprise a network element and/or a power supply module of a network element for converting the AC electrical power signal into a DC signal for powering at least one component of the communication network. For instance, in one example, the method 200 may be performed independently or primarily by a network element itself, e.g., without instructions from an OAM system, SDN controller, SON orchestrator, RAN intelligent controller, or other management system of the communication network.

At step 220, the processing system detects an electrical power event of an AC electrical power distribution network (e.g., a degradation event such as a blackout, brownout, demand in excess of capacity, etc.). For example, the processing system may receive electrical power data from one or more network elements from which the electrical power event may be detected. In other words, in one example, the electrical power event may be detected in accordance with electrical power data from one or more network elements of the communication network, e.g., from the PSUs thereof, and/or from power probes in data centers of the communication network associated with different racks, chassis, blades, etc. (e.g., dedicated network elements for AC electrical power monitoring). Alternatively, or in addition, in one example, the electrical power event may be detected in accordance with electrical power data from the AC electrical power distribution network. For instance, in one example, the electrical power data may be modulated onto an AC electrical power signal from the AC electrical power distribution network. In one particular example, the electrical power data may include an indicator of the severity level from among the different severity levels (and may indicate a type of electrical power event, etc.). In one example, the electrical power data may be extracted from the AC electrical power signal via one or more network elements of the communication network (e.g., the PSUs thereof, e.g., smart PSUs). In another example, the processing system may obtain electrical power data from the AC electrical power distribution network via an API or the like.

As noted above, the electrical power data may include voltage/amplitude, frequency, current, etc., and can also include aggregate measures such as uniformity, and so forth. However, it should again be noted that in one example, the electric power data may include one or more explicit indications of a detection of the electrical power event by one or more network elements and/or by the AC electrical power distribution network. In one example, the electrical power event may comprise a loss of electrical power event and/or an excess demand electrical power event. It should be noted that for present purposes, “loss” can include a reduction from what is normal/typical, e.g., deviation from a daily moving average, a 3-day moving average, a weekly moving average, a weekly moving average for the particular time of day, and/or a monthly moving average for a time of day, day of the week, etc. It should also be noted that excess demand can be in excess of what the AC electrical power distribution network can support (which in some cases could be highly localized). In one example, an electrical power event may also comprise a reduced power delivery capacity in conjunction with excess demand.

In one example, the electrical power event may comprise a forecast/predicted electrical power event. In one example, step 220 may include detecting a severity level of the electrical power event. In one example, the different severity levels of electrical power events may comprise defined severity levels according to one or more factors. For example, the severity level may be determined in accordance with various thresholds, weighted formulas, or the like, which may be applied the electrical power data to detect an electrical power event, and the particular severity level thereof. For instance, a first severity level, e.g., level 1, may be associated with minor electrical power events with minor impacts (e.g., on the order of seconds, affecting one or a few network elements, etc.), a second severity level, e.g., level 2, may be associated with moderate electrical power events (e.g., longer duration such as tens of seconds or minutes, more widespread, etc.), and a third severity level, e.g., level 3, may be associated with significant electrical power events (e.g., more widespread blackouts, durations on the order of minutes to hours or days, etc.). In one example, the electrical power event (current, or forecast/predicted) may be detected via at least one machine learning model implemented by the processing system. For example, inputs to the MLM(s) may include electrical power data from at least one of: one or more network elements, or the alternating current electrical power distribution network. In one example, an output of the machine learning model(s) may comprise a severity level (where possible severity levels can include level 0/no electrical power event). In one example, inputs to the MLM(s) may include external data such as weather data, or the like (where the MLM training may be similarly based on training samples including weather data for various locations or areas, such as temperature, ultraviolet index, humidity, weather type (e.g., rain, snow, etc.) and/or metrics thereof (e.g., a number of centimeters or inches of rain, snow, etc., a rate of precipitation or accumulation, start and end time, and so forth).

At step 230, the processing system may select one or more remedial actions in the communication network in response to the severity level of the electrical power event, where the processing system may be configured to apply different sets of one or more remedial actions for different severity levels of electrical power events. To illustrate, when the severity level comprises a first severity level, the one or more remedial actions may include at least one of: reducing data processing tasks that are designated as non-critical task at one or more network elements of the communication network, or reducing processor speed at one or more of the network elements. In one example, the one or more network elements may be in an affected network zone/region. In one example, the one or more network elements may be associated with a particular network slice, e.g., a slice that is not associated with first responders, governmental users, or the like. In one example, when the severity level comprises a second severity level (e.g., that is more severe than the first severity level according to one or more thresholds and/or MLM-based detection or the like) the one or more remedial actions may include at least one of: reducing network capacity of the communication network for non-essential data traffic, or imposing endpoint device connection limits for one or more access points of the communication network (e.g., base stations or the like). In one example, when the severity level comprises a third severity level (e.g., that is more severe than the second severity level according to one or more thresholds and/or MLM-based detection or the like), the one or more remedial actions may include at least one of: shutting down one or more network elements that are designated as non-critical network elements (e.g., including physical components, as well as VNFs or the like), blocking data traffic for non-emergency services (e.g., data traffic for first responders and governmental users/entities only—others can utilize SMS and can place emergency calls (e.g., 911/E911, or the like)—in one example “blocking” can include “dropping” at the access point or at another network element), configuring one or more of the network elements to maintain a low-power hibernation mode, or configuring an operations, administration, and management system of the communication network to operate in a standby mode (e.g., while maintaining functionality of the present disclosure related to AC electrical power event monitoring and response).

In one example, the one or more remedial actions may include transmitting instructions to one or more endpoint devices to reduce data traffic for the one or more endpoint devices across the communication network, e.g., where the one or more endpoint devices may be selected based on the severity level. For instance, the remedial action(s) may include instructions to activate power saving modes, which may slow or disable background processes, and which can result in a reduction of data traffic across the network. Alternatively, or in addition, the instructions may be instructions to prioritize critical network traffic, or traffic that may support critical services, such as prioritizing SMS, which may allow sufficient communication, but with minimal increase in the power demand of the communication network. In one example, the selected endpoint devices may be endpoint devices that are not associated with subscriptions for continuity of network service during electrical power events (and non-first responder or non-governmental users/endpoint devices or the like). In one example, the instructions may be to endpoint devices (e.g., IoT devices) to send data reports on a different schedule. In still another example, the one or more remedial actions for one or more of the severity levels may alternatively or additionally include instantiating network elements in areas of the communication network that are not experiencing an electrical power event.

At step 240, the processing system implements the one or more remedial actions to reconfigure the communication network in response to the severity level of the electrical power event. For instance, step 240 may include transmitting instructions directly to various network elements (e.g., where “directly” may include one or more intermediate network elements that may only process the communications for layer 2 and/or layer 3 routing, for example). Alternatively, or in addition, the processing system may transmit instructions to another network element or system, such as an SDN controller, SON orchestrator, SMO, RAN intelligent controller, or the like to configure/reconfigure the network (e.g., to configure/reconfigure various network elements). For instance, the processing system may provide instructions to an SDN controller or the like to initiate level 1, level 2, or level 3 power saving procedures, may indicate a target network element, set of network elements, network zone/region, or the like, and so forth. The SDN controller may then disseminate instructions to various network elements accordingly. Similarly, in one example, the processing system may work in conjunction with access network components, e.g., access management functions (AMFs), session management functions (SMFs), cellular base stations, etc. or a RAN intelligent controller (RIC) to transmit instructions to various endpoint devices for power saving mode activation and/or specifically for reducing non-essential network traffic, e.g., depending on the severity level and the corresponding set of one or more remedial actions.

At optional step 250, the processing system may generate an energy utilization score for at least one endpoint device based upon: a data traffic volume across the communication network for the endpoint device, a data traffic type of the data traffic, and a network congestion level. For instance, optional step 250 may comprise generating a context-aware energy score (CAES), such as described above. In one example, the energy utilization score may be further based upon a severity level of the electrical power event.

At optional step 260, the processing system may generate a service charge for the at least one endpoint device that is a function of the energy utilization score (e.g., a CAES or the like). Alternatively, or in addition, the processing system may designate the at least one endpoint device for an increased likelihood of having its connections blocked and/or rate limited, an increased likelihood of being instructed to activate a power-saving mode and/or a reduced data utilization mode, or the like. For instance, each endpoint device may be assigned a score/value that indicates a relative likelihood of being selected for various remedial actions, e.g., at step 230, in response to electrical power events as described herein.

Following step 240 or optional step 260, the method 200 proceeds to step 295 where the method ends.

It should be noted that the method 200 may be expanded to include additional steps, or may be modified to replace steps with different steps, to combine steps, to omit steps, to perform steps in a different order, and so forth. For instance, in one example, the processing system may repeat steps 210-240, steps 220-240, or steps 210-260, etc. on an ongoing basis to continue to obtain electrical power data, to detect electrical power events, and to reconfigure the communication network accordingly. In one example, the method 200 may be expanded or modified to include steps, functions, and/or operations, or other features described above in connection with the example(s) of FIG. 1 or as described elsewhere herein. Thus, these and other modifications are all contemplated within the scope of the present disclosure.

In addition, although not expressly specified above, one or more steps of the method 200 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. Furthermore, operations, steps or blocks of the above-described method(s) can be combined, separated, and/or performed in a different order from that described above, without departing from the example embodiments of the present disclosure.

FIG. 3 depicts a high-level block diagram of a computing device or processing system specifically programmed to perform the functions described herein. For example, any one or more components or devices illustrated in FIG. 1 or described in connection with the example(s) of FIG. 2 may be implemented as the processing system 300. As depicted in FIG. 3, the processing system 300 comprises one or more hardware processor elements 302 (e.g., a microprocessor, a central processing unit (CPU) and the like), a memory 304, (e.g., random access memory (RAM), read only memory (ROM), a disk drive, an optical drive, a magnetic drive, and/or a Universal Serial Bus (USB) drive), a module 305 for implementing one or more remedial actions in a communication network in response to a severity level of a detected electrical power event, and various input/output devices 306, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one processor element is shown, it should be noted that the computing device may employ a plurality of processor elements. Furthermore, although only one computing device is shown in the Figure, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of this Figure is intended to represent each of those multiple specific-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 302 can also be configured or programmed to cause other devices to perform one or more operations as discussed above. In other words, the hardware processor 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above-disclosed method(s). In one example, instructions and data for the present module or process 305 for implementing one or more remedial actions in a communication network in response to a severity level of a detected electrical power event (e.g., a software program comprising computer-executable instructions) can be loaded into memory 304 and executed by hardware processor element 302 to implement the steps, functions or operations as discussed above in connection with the example method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above-described method(s) can be perceived as a programmed processor or a specialized processor. As such, the present module 305 for implementing one or more remedial actions in a communication network in response to a severity level of a detected electrical power event (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
detecting, by a processing system including at least one processor of a communication network, an electrical power event of an alternating current electrical power distribution network;
selecting, by the processing system, one or more remedial actions in the communication network in response to a severity level of the electrical power event, wherein the processing system is configured to apply different sets of one or more remedial actions for different severity levels of electrical power events; and
implementing, by the processing system, the one or more remedial actions to reconfigure the communication network in response to the severity level of the electrical power event.

2. The method of claim 1, wherein the communication network comprises a wireless network.

3. The method of claim 1, wherein the different severity levels of electrical power events comprise defined severity levels according to one or more factors.

4. The method of claim 1, wherein the electrical power event is detected in accordance with electrical power data from one or more network elements of the communication network.

5. The method of claim 4, wherein the electrical power data includes at least one of:
a voltage measure;
a frequency;
a current measure; or
a uniformity measure.

6. The method of claim 1, wherein the electrical power event is detected in accordance with electrical power data from the alternating current electrical power distribution network.

7. The method of claim 6, wherein the electrical power data is modulated onto an alternating current electrical power signal from the alternating current electrical power distribution network.

8. The method of claim 7, wherein the electrical power data comprises an indicator of the severity level from among the different severity levels.

9. The method of claim 1, wherein the electrical power event comprises a forecast electrical power event.

10. The method of claim 9, wherein the electrical power event is detected via at least one machine learning model implemented by the processing system.

11. The method of claim 10, wherein inputs to the at least one machine learning model include electrical power data from at least one of:
one or more network elements; or
the alternating current electrical power distribution network, and wherein an output of the machine learning model comprises the severity level.

12. The method of claim 11, wherein the at least one machine learning model is trained in accordance with a training data set comprising historical sets of electrical power data of the one or more network elements, wherein the historical sets of electrical power data are associated with respective labels indicating respective severity levels of electrical power events.

13. The method of claim 1, wherein the electrical power event comprises at least one of:
a loss of electrical power event; or
an excess demand electrical power event.

14. The method of claim 1, wherein when the severity level comprises a first severity level, the one or more remedial actions include at least one of:
reducing data processing tasks that are designated as non-critical task at one or more network elements of the communication network; or
reducing processor speed at the one or more of the network elements.

15. The method of claim 14, wherein when the severity level comprises a second severity level that is more severe than the first severity level, the one or more remedial actions include at least one of:
reducing a network capacity of the communication network for non-essential data traffic; or
imposing endpoint device connection limits for one or more access points of the communication network.

16. The method of claim 15, wherein when the severity level comprises a third severity level that is more severe than the second severity level, the one or more remedial actions include at least one of:
shutting down one or more network elements that are designated as non-critical network elements;
blocking data traffic for non-emergency services;
configuring one or more of the network elements to maintain a low-power hibernation mode; or
configuring an operations, administration, and management system of the communication network to operate in a standby mode.

17. The method of claim 1, wherein the one or more remedial actions include:
transmitting instructions to one or more endpoint devices to reduce data traffic for the one or more endpoint devices across the communication network.

18. The method of claim 17, wherein the one or more endpoint devices comprise endpoint devices that are not associated with subscriptions for continuity of network service during electrical power events.

19. A non-transitory computer-readable medium storing instructions which, when executed by a processing system including at least one processor deployed in a communication network, cause the processing system to perform operations, the operations comprising:
detecting an electrical power event of an alternating current electrical power distribution network;
selecting one or more remedial actions in the communication network in response to a severity level of the electrical power event, wherein the processing system is configured to apply different sets of one or more remedial actions for different severity levels of electrical power events; and
implementing the one or more remedial actions to reconfigure the communication network in response to the severity level of the electrical power event.

20. An apparatus comprising:
a processing system including at least one processor; and
a non-transitory computer-readable medium storing instructions which, when executed by the processing system when deployed in a communication network, cause the processing system to perform operations, the operations comprising:
detecting an electrical power event of an alternating current electrical power distribution network;
selecting one or more remedial actions in the communication network in response to a severity level of the electrical power event, wherein the processing system is configured to apply different sets of one or more remedial actions for different severity levels of electrical power events; and
implementing the one or more remedial actions to reconfigure the communication network in response to the severity level of the electrical power event.
